(19) United States
(12) Patent Application Publication
(10) Pub. No.: US 2008/0244095 A1
(43) Pub. Date: Oct. 2, 2008

(54) SYSTEM AND METHOD FOR SELECTING NETWORK ACCESS TECHNOLOGY

(76) Inventors: Gustav Gerald Vos, Surrey (CA); William Waung, Burnaby (CA)

Correspondence Address: THELEN REID BROWN RAYSMAN & STEINER LLP, PO BOX 640640, SAN JOSE, CA, 95164-0640, US

(21) Appl. No.: 12/057,888

(22) Filed: Mar. 28, 2008

Related U.S. Application Data
(60) Provisional application No. 60/920,632, filed on Mar. 28, 2007.

(51) Int. Cl. G06F 15/16

(52) U.S. Cl. 709/250

(57) ABSTRACT

Disclosed is an algorithm for selecting optimum network access technology. The algorithm includes collecting network quality measurement data for one or more available network access technologies. Then, calculating based on the collected network quality measurement data one or more normalized quality attributes for one or more available network access technologies. Next, generating based on the one or more normalized quality attributes one or more quality metrics for one or more available network access technologies. Finally, selecting an optimum network access technology from the one or more available network access technologies based on the quality metrics of available network access technologies.

### CROSS REFERENCE TO RELATED APPLICATIONS

This application claim benefit of the U.S. Provisional Application Ser. No. 60/920,632, filed on Mar. 28, 2007, which is incorporated by referenced herein.

### TECHNICAL FIELD

The present disclosure relates to the field of communication networks and, more specifically, to the systems and methods for selecting network access technology.

### BACKGROUND

Modern personal computing device, such as personal and laptop computers, cell phones and personal digital assistants (PDA), frequently provide data connectivity through wired and wireless networks, such as ISDN, Ethernet, ATM, CDMA, GSM, UMTS, WiFi, Bluetooth and the like. Some computing devices frequently provide several different choices for data connectivity through multiple radio access technologies and, thus, require an access technology selection algorithm (ATSA) to optimize the user connection. The access technology selection algorithm is responsible for choosing the best access technology for data and/or voice connection. There are several challenges and optimization that need to be considered in the design of an ATSA.

The decision of the access technology selection algorithm is primarily about optimizing the user experience, but there are several factors that may affect that experience: cost of the data transaction, data throughput in the uplink, data throughput in the downlink, and delay in the channel or RTT (return turnaround time) and other factors know to those of skill in the art. To further complicate the optimization process, all four of these factors change in time even when the user is stationary. The access technology selection algorithm needs to be able to continually optimize for all of these factors.

Another challenge for the access technology selection algorithm is that all the different access technologies provide their signals in different units. For example, a GSM terminal uses SNR (signal to noise ratio), a CDMA terminal uses E_{b}/Nₜ (energy per bit to noise density ratio), and a WiMAX terminal will use CINR (carrier to interference plus noise ratio) to indicate its signal quality level. If the access technology selection algorithm simply compares these, it will often not choose the optimal access technology.

If the access technologies are mainly radio access technologies, then these conditions can change dramatically even if the user is stationary as many WWAN technologies such as CDMA are known to breathe (cells get bigger and smaller based on loading). The access technology selection algorithm needs to make sure that it does not get into a situation where it is switching back and forth between two access technologies. The access technology selection algorithm needs to consider the effect of switching between the technologies. Sometimes the access technology switch will be fairly quick and non-evasive but other access technology switches take more time and cause other deleterious affects. One such effect would be a change in assigned IP (internet protocol) address which may cause many connected programs to lose any state information. An example of such a program would be a VPN (virtual private network). Most VPNs will require re-establishment when the underlying IP address changes.

The degree the access technology transition influences the user's experience is also dependent on the user's data activity level. For example, if the user is not currently sending or receiving data, the affect of an access technology transition and the associated momentary loss of connectivity will be small. In contrast, the user's experience will be greatly affected if the transition occurs when data is actively being sent or received across the link. Thus, the access technology selection algorithm must consider the user's data actively level in its access technology selection decision.

The maximum and average data throughput of each of the access technologies choices may also be factored into the access technology selection algorithm decision. For example, even if the signal quality of a the GSM-GPRS modem is very good, the throughput and round trip time(RTT) performance the user experiences may be better using a marginal WiMAX connection because the data throughput for a given SNR is typically better for a WiMAX system. However this is not always the case as the quality of the access terminal (AT) itself may play an important factor. Items such as the noise figure of the radio, MIMO support, and channel decoding performance may allow some access technology implementation to outperform other implementations in the same SNR and RSSI. Thus, the ATSA should not be implementation neutral.

Yet another factor the access technology selection algorithm needs to consider is the congestion in the access technology network. Even if the signal level is good on an access technology, the data throughput and RTT performance of the access technology maybe bad if it is congested when compared to other possible access technology choices.

A more subtle challenge for an access technology system algorithm is its ability to communicate what is happening to the end users. When a technology transition has taken place, the access technology system algorithm may need to be able to communicate the reason for the transition in terms that are understandable to the user.

### OVERVIEW

Disclosed is an optimized access technology selection algorithm for use in a system which has multiple data access technology choices. The algorithm is such that it chooses the most desirable technology based on a quality metric. The quality metric is composed of a linear and functional combination of normalized quality attributes. The quality attributes are normalized such that the end user can easily interpret them. The algorithm uses two sets of thresholds. The first set are minimum quality thresholds used to protect the user from inadvertently switching and to allow technology biasing. The minimum quality threshold is dependent on the currently active access technology and the current data access state. The second set of thresholds are delta quality thresholds which are compared against the delta between the current access technology and all the possible candidate access technologies. The delta threshold's main purpose is to insure the candidate access technology is greater then a delta above the currently active technology before allowing a switch. The delta quality threshold may be dependent on the currently active access technology, the candidate access technology, and the data access state.

### BRIEF DESCRIPTION OF DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a block diagram illustrating one example embodiment of a computer system having multiple network access technologies;

FIG. 2 is a flow diagram illustrating one example embodiment of an access technology selection algorithm;

FIG. 3 illustrates one example embodiment of attribute normalization equations; and

FIG. 4 illustrates one example embodiment of quality metric normalization equation.

### DETAILED DESCRIPTION OF EXAMPLE EMBODIMENTS

Those of ordinary skill in the art will realize that the following description of network access technology selection algorithms are illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations of network access technology selection algorithms are shown and described. It will, of course, be appreciated that in the development of any such actual implementation of the network access mechanism, numerous implementation-specific decisions must be made in order to achieve the developer's specific goals, such as compliance with application-, system-, network-and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of telecommunication networks having the benefit of this disclosure.

In accordance with this disclosure, the components, process steps, and/or data structures described herein may be implemented using various types of operating systems, computing platforms, network devices, computer programs, and/or general purpose machine s. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium.

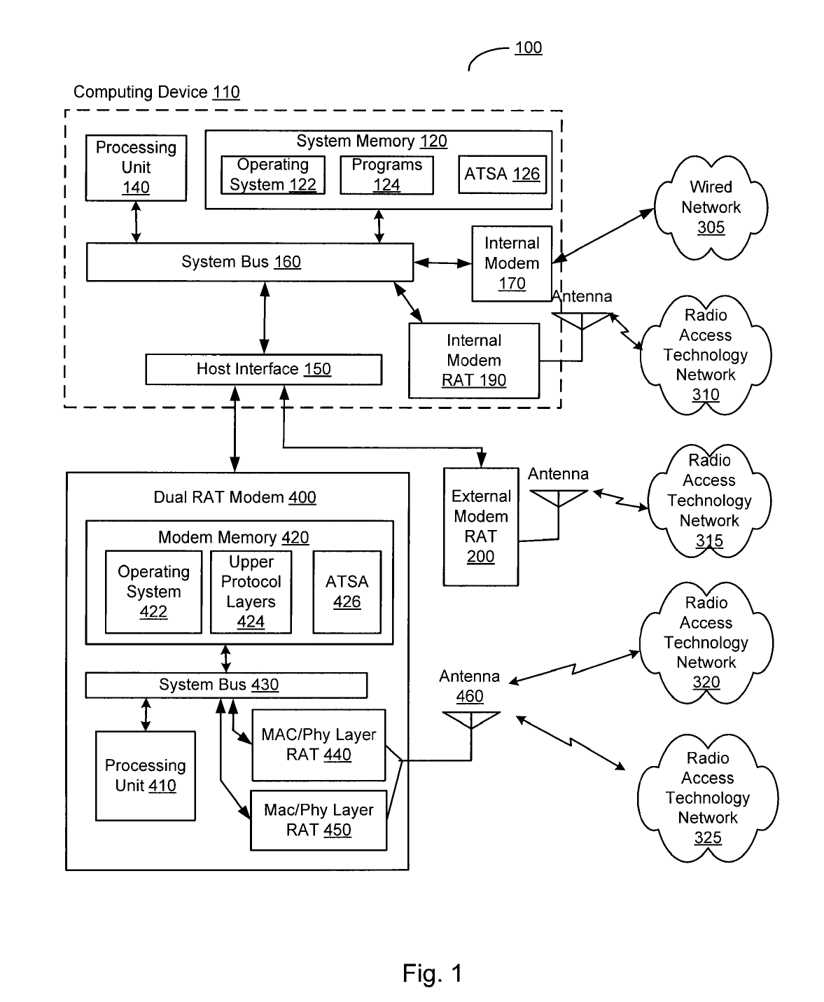

The block diagram in FIG. 1 illustrates one example embodiment of computer system with the capability to perform data communications over one or more communication networks in accordance with principles described herein. Computer system 100 may include, but is not limited to, a personal computer, a laptop computer, a tablet computers, a notebook computer, an ultra-mobile personal computer, a server, a cellular phone, a personal digital assistant, a multimedia device, such as audio player, video player, gaming machine console, digital camera, video camera, navigation system or other types of devices. In one example embodiment, computer system 100 may be able to support two or more wired or wireless network access technologies for communicating with other devices over data/voice networks 305, 310, 315, 320 and 325.

The communication networks 305-325 may connect computer systems 100 to a local area network (LAN), wide area network (WAN), wireless metropolitan area network (WMAN), cellular network, piconet, intranet, Internet or other type of computer network. In various embodiments, networks 305-325 may be wired or wireless, which are also referred herein as radio access technology (RAT) networks. In one example embodiment, wired communication network 305 may include, but is not limited to, integrated services digital network (ISDN), Ethernet, gigabit Ethernet, Asynchronous Transfer Mode (ATM) and other type of wired networks known to skilled in the art. RAT networks 310 through 325 may include, but are not limited to, WiFi (IEEE 802.11a, b, g, n), WiMAX (IEEE 802.16), 3GPP network, such as UMTS, GSM, HSDPA or LTE networks, 3GPP2 networks, such as CDMA or EV-DO, Bluetooth or other types of wireless or cellular communication networks known to skilled in the art.

In one example embodiment, computer system 100 may include a general purpose computing device 110, which includes a processing unit 140, such as an Intel® Dual-Core™ or Pentium® processors, an AMD Turion™ 64 processor or other types of CPU. Device 110 further includes a system memory 120, such as a random access memory (RAM), a read only memory (ROM), a programmable ROM (PROM), an erasable PROM (EPROM), a FLASH-EPROM and other types of dynamic, volatile and nonvolatile information storage medium. In one example embodiment, memory 120 stores an operation system (OS) 122, programs or applications 124, and an access technology system algorithm (ATSA) 126. Device 110 further includes one or more wired and/or RAT networking interface devices that enable connection of the device 110 to the one or more wired and RAT networks 305, 310, 315, 320 and 325 described above.

In one example embodiment, networking interface devices may be internal or external to the device 110. For example, internal modem 170 may include a PCI-based Ethernet card or a dial-up modem for connecting device 110 to the wired network 305. Internal RAT modem 190 may include a PCI-based WLAN, GSM or CDMA card that connects device 110 to the wireless and/or cellular network 310. Being internal to device 110, modems 170 and 190 may be directly connected to the system bus 160. External networking devices may include a RAT modem 200, which provides connection to a wireless or cellular network 315, and a dual RAT modem 400, which provides connection to networks 320 and 325. External devices 200 and 400 may be connected to the device 110 through a host interface 150, such as a USB, FireWire, PCMCI, Ethernet, WLAN or other types of data communication interfaces known in the art.

FIG. 1 also depicts one example embodiment of the external RAT networking devices 400 configured to support two or more radio access technologies. Device 400 may include, but is not limited to, a wireless access point, wireless cable modem, wireless router or other type of RF network access device. Device 400 may include a processor 410, system memory 420, system bus 430 and two (or more) MAC/Physical layer RAT interfaces 440 and 450, which enable device communication with RAT networks 320 and 325, respectively. For example, interfaces 440 and 450 may include IEEE 802.11b and 802.11n interfaces, respectively. In another example, interfaces 440 and 450 may include Bluetooth and EVDO interfaces. Device 400 may also include one or more RF antennas 460 for transmitting and receiving radio signals. In one example embodiment, memory 430 may store OS 422, upper networking protocol layers 424 for RAT interfaces 440 and 450 and an access technology system algorithm 426, which may be similar to ATSA 126.

In one example embodiment, the access technology system algorithm enables system 100 to choose the optimum network access technology from the available network technologies. The ATSA may be implemented as a computer program executable by a general purpose processor. In one example embodiment, the access technology system algorithm 126 may reside in the memory of computing device 110 which has two or more access technology interfaces, such as interfaces 170, 190 and 200. In another example embodiment, the access technology system algorithm 426 may reside within the multi-access technology modem 400, which provides network access two system 100 via RAT interfaces 440 and 450. Those of skill in the art may recognize that it is sometimes advantageous to have multiple ATSA, such as algorithms 126 and 426, within networked computing system 100, which would work independently in a hierarchical manner.

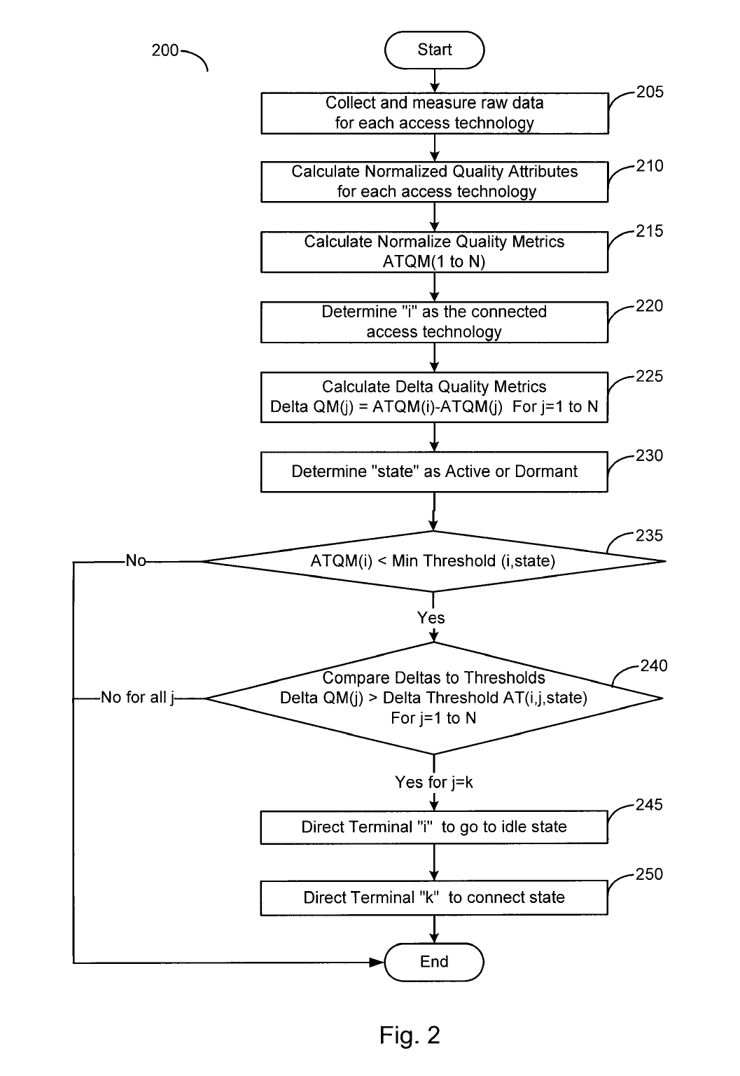

FIG. 2 is a flow diagram of one example embodiment of an access technology selection algorithm 200 for N possibly connected access technologies. The ATSA 200 may be executed on a periodic or event driven asynchronous schedule. At step 205, raw network data including, but not limited to, signal quality, signal to noise, cost, RTT, congestion, uplink data speed, downlink data speed, uplink queue size, access technology switch times and IP session integrity are measured and collected by the system. At step 210, the normalized quality attributes including, but not limited to, speed, cost and RTT are calculated for each access technology base on the raw network data. At step 215, a single access technology quality metric (ATQM) is calculated for each access technology in using the normalized quality attributes. At step 220, the currently connected access technology is determined and stored in variable “i”. At step 225, the delta quality metrics (Delta QM(1 to N)) are calculated, as the differences between the connected access technology quality metric ATQM(i) and all other access technologies quality metrics.

Next, the data activity state of the connection is determined at step 230. Example data activity states include, but not limited to, dormant (no user activity), low active (recent or currently user activity), and high active (high rate of data currently being transferred). At step 235, the connected access technology quality metric is compared to a minimum threshold for its data activity state to determine if a switch to another access technology system should even be considered. If the current access technology quality metric ATQM(i) is above the minimum threshold no further switch is considered and the access technology selection algorithm 200 ends. If the ATQM(i) is below a minimum quality level, a switch to another access technology may be further considered.

The next step in the access technology selection algorithm 200 is to compare the Delta QM(j) array with the delta threshold (i, j, state) matrix for each value of j=1 to N at step 240. If no Delta QM's are above the delta threshold then a switch is not necessary at this time and the algorithm may terminate, otherwise an access technology switch may be initiated. In one example embodiment, an access technology switch is initiated first by directing the currently connect modem to go into idle mode (not able to transfer data any longer) at step 245. Secondly, the access technology system, which exceeded the delta threshold, will be directed to enter the connected state (able to transfer data) at step 250. Those of skill in the art may recognize that there are many other methods for effectuating a switch between two access technology systems, which may be used herein.

Several example techniques for collecting and measuring raw network information about available access technologies in the ATSA 200, step 205, are described next. Those of skill in the art will recognize that these techniques are merely exemplary and other methods for collection and measurement of raw network data may be used in various alternative embodiments. In one example embodiment, the contributing information that needs to be collected may be available from the access terminal via a control messages or application programming interfaces. These types of attributes may include but not limit to RSSI, SNR, Eb/Nt and CINR. Other attributes are less common across these interfaces, so other methods may be used to obtain them.

For example, cost per byte is typically not available, but can be included as information element in 802.21 MIH messages or other higher layer message. Cost can also be preprogrammed into the access terminal at factory provisioning or obtained by over-the-air (OTA) messaging from the serving network.

Channel delay or RTT (round trip turnaround time) is also not typically available but this can be measured or obtained by the ATSA in several ways: OTA message from the serving network, measured and then averaged based on TCP acknowledgment times, or the time it takes to receive one full window of data (useful when only receiving data), or through an active message such as a ping. If an active method is used, the periodicity of the active message should considered such factors as signal quality, cost, power consumption, and probability of a switch as criteria.

UL (uplink) and DL (downlink) congestion are also not typically available via control messaging from the access terminal. Congestion in the network can be a major factor that deleteriously affects both speed and RTT for the access technology. Typically, the level of congestion is transmitted in an OTA message that can be decoded by the access terminal and then sent to the ATSA. The OTA message should contain both an UL and DL congestion indication. This OTA message does not necessarily need to be specifically designated or designed to communicate just congestion. In most access system protocols, the congestion can be inferred by decoding the existing OTA MAC (media access control) messages that are used to assign OTA resources. For example, the MAP message in a WiMAX network can be used to infer congestions as it defines the resource allocation for the upcoming UL and DL frames. Preferably, the units of congestion are in seconds and represent the current UL and DL, queuing times.

Sustainable and obtainable UL and DL speeds are not typically available via control messaging to the access terminal. UL sustainable speeds may be measure by the currently connected modem by directly monitoring the UL data flow. To ensure that the host data source is not limiting this measurement, the active modem should only take this measurement when there is an UL queue of appropriate depth. Sustainable and obtainable DL speed is typically more difficult to measure because it is difficult to determine when the data source or the access technology link is creating the limitation.

Several example methods for generating the normalized access technology quality attributes of the ATSA 200, step 210, are described next. Using this large set of raw access technology information, a smaller set of normalized user quality attributes are calculated such as, but not limited to, UL throughput attribute, DL throughput attribute, cost attribute, RTT attribute, and access technology transition factor. The normalization of each of these quality attributes may be such that they are in the units which the user would perceive them, such as kbps, $/Kbyte, and seconds. The normalization transformations and coefficients may be unique for each RAT system.

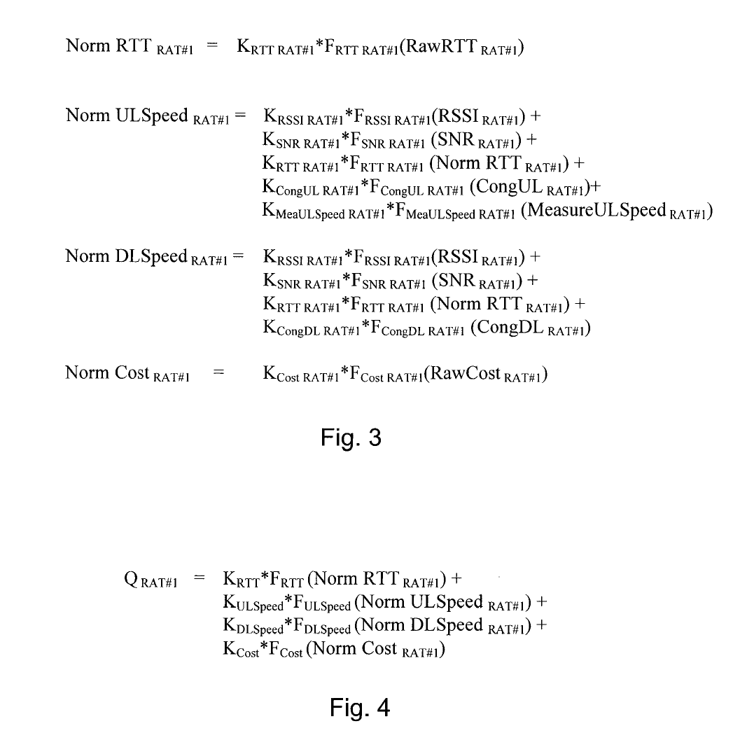

FIG. 3 shows example equations that can be used to calculate the normalized quality attributes. In the equations, Kₓₓₓₓ refer to constants that are access technology specific (change depending on the access technology). Fₓₓₓₓ refer to translation functions. These functions may be various logarithm functions know to those skilled in the art or be more complex functions such as, but not limited to, lookup tables or subroutines. The values of Kₓₓₓₓ and the functions Fₓₓₓₓ may be selected to normalize the raw access technology information into user identifiable units. The values of Kₓₓₓₓ and the functions Fₓₓₓₓ in may be determined mathematically or experimentally, using techniques know to those skilled in the art. Although the values of Kₓₓₓₓ and the functions Fₓₓₓₓ may be determined and pre-provisioned at assembly, these values can be modified by the network operator via over-the-air messaging if adjustments are needed.

Norm RTT_{RAT#1} is the normalize RTT quality attribute for the radio access technology 310. Norm RTT_{RAT#1} should ideally have units of seconds. Having the units in seconds is preferred, as the ATSA could display these to the end user or technician who can more easily validate and interpret them. In the situations, where RTT cannot be obtained, a pre-provisioned best estimated for the value should be used.

Norm UPSpeed_{RAT#1} is the normalize UL Speed attribute for the radio access technology 310. Norm UPSpeed_{RAT#1} should ideally now represent the realistic UL data speed in units of bytes/sec. Having the units in bytes/seconds is preferred as the ATSA could now display these to the end user or technician who can more easily validate and interpret them. In the situations where some of the raw measurements, such as MeasureULSpeed_{RAT#1}, can not be obtained, the corresponding constant, such as K_{MeaULSpeed RAT#1}, shall be set to zero, effectively zeroing out any effect of the missing information.

Norm DLSpeed_{RAT#1} is the normalize DL Speed attribute for the radio access technology 310 and similarly should be in units of bytes/sec for similar reasons as stated above for DLSpeed_{RAT#1}

Norm Cost_{RAT#1} is the normalized Cost attribute for the radio access technology 310. Norm Cost_{RAT#1} may represent the cost per byte. Having the units in $/byte is preferred as the ATSA could now display these to the end user or technician who can more easily validate and interpret them.

Several example methods for generating the access technology quality metric of the ATSA 200, step 215, are described next. All the quality attributes from each of the access technologies may be combined into a single quality metric for each access technology. Unlike the quality attributes, the same combinatory calculation will be used for calculating the quality metric for all access technologies. This quality metric should now be unbiased toward implementation and access technology.

FIG. 3 shows one example equation that can be used to calculate the quality metric. Kₓₓₓₓ in refer to constants that are now access technology neutral (same constant for each technology). Fₓₓₓₓ in refer to translation functions. These functions may be as simple as a logarithm function or be more complex like a lookup table or subroutine. The values of Kₓₓₓₓ and the functions Fₓₓₓₓ are used to weight the importance of the quality attributes. Since this is often highly personal it is recommended this be adjustable by the network operator and/or end user. Although the values of Kₓₓₓₓ and the functions Fₓₓₓₓ may be pre-provisioned at assembly, these values may be modified by the network operator via over-the-air messaging or through a user interface if adjustments needed.

Q_{RAT#1} is the normalize quality metric for the radio access technology 310. In FIG. 2, Q_{RAT#1} may be equivalent to ATQM(1). Since Q_{RAT#1} is a combination of cost, speed, and RTT it does not have any real units but for user perception, it is recommended that a quality metric of zero be defined as no connection possible. It is also recommended that increases in the quality metric indicate an increase in signal quality, decreases in cost/byte, and decreases in delay.

Since the signal quality can often vary quickly in a radio access technology it is recommended that the quality metrics for each of the access technologies be smoothed or averaged. There are many algorithms available for smoothing such as but not limited to using a single pole infinite impulse response filter. The period or the amount of filtering will depend on the access technology, so it is recommended that different amounts of filter be used for each access technology.

Several example methods for the determination of what access data state the connected access technology is in the ATSA, step 230, are described next. The state of the connected access terminal needs to be determined so that the appropriate sets of thresholds can be used. The data state can be determined by monitoring the rate and timing of the data traffic through it. The “dormant”, “low active”, and “high active” states are only exemplary, so other possible states could also be considered which give more granularity to the algorithm. There is no limitation to how many access data states the ATSA can support.

Several example methods for the comparison of the access terminal quality metric to the minimum threshold in the ATSA 200, step 235, are described next. The purpose of this comparison is to ensure that a transition is not taken if the current quality level is above a specified minimum level. Depending on the threshold level, this gate adds some immunity toward rapid switching between access technologies. This threshold allows the preference or bias towards or away from for one technology over the next by using different thresholds for each access technology. Since the threshold is also dependent on the data state, this comparison can bias a switch towards a dormant state. For example, this may be accomplished by setting the minimum dormant quality threshold higher than the minimum active quality threshold or using other methods.

Several example methods for the comparison of the delta quality metric to the delta threshold in the ATSA 200, step 240, are described next. The purpose of this comparison is to ensure that a transition is only executed if the current quality metric is larger than a certain delta above an alternate technology. This threshold allows the preference or biasing towards or away from for one technology over the next by using different thresholds for each access technology. If the delta threshold used is positive, this comparison adds some immunity toward rapidly switching between access technologies or hysteresis. If the delta threshold is negative it will bias the switch towards that access technology. Since the threshold is also dependent on the data state, this comparison can bias a switch towards a dormant state. This may be accomplished by setting the delta dormant quality threshold lower than the delta active quality threshold.

Since this threshold is dependent on the current access technology and the candidate access technology, the threshold can bias against difficult transition where the time it takes to do the transition is longer or the loss of IP address occurs during that transition. Since these factors can vary depending on location and other factors, it is recommended that the delta threshold matrix be dynamic and adjust for these changes in transitions time, and IP connectivity changes. The determination of what the transition time is and IP connectivity consequences for each transition can be provisioned at manufacturing, learned by experience (store the length of time a transition took and what the consequences were), or obtained or updated through OTA messaging from the network.

While particular embodiments of the present invention have been shown and described, it will now be apparent to those skilled in the art having the benefit of this disclosure that many more modifications than mentioned above are possible without departing from the inventive concepts disclosed herein. Therefore, the appended claims are intended to encompass within their scope all such modifications as are within the spirit scope of this invention.

What is claimed is:

1. A method for selecting a network access technology, the method comprising:
collecting network quality measurement data for one or more available network access technologies;
calculating based on the collected network quality measurement data one or more normalized quality attributes for one or more available network access technologies;
calculating based on the one or more normalized quality attributes one or more quality metrics for one or more available network access technologies; and
selecting an optimum network access technology from the one or more available network access technologies based on the quality metrics of network access technologies.

2. The method of claim 1, wherein one of the available network access technologies includes at least one active network access technology.

3. The method of claim 2, wherein selecting the optimum network access technology further includes comparing the quality metric for the active network access technology with a minimum quality threshold to determine whether switching to another available network access technology is necessary.

4. The method of claim 3 further comprising
computing one or more delta quality metrics as a difference between the quality metric for the active network access technology and the quality metrics for the one or more available network access technologies;
comparing the delta quality metrics with an access technology delta threshold to determine the optimum network access technology; and
switching from the active network access technology to the optimum network access technology identified by the delta quality metric that exceeds the access technology delta threshold.

5. The method of claim 1, wherein the normalized quality attributes are constructed using a linear and functional combination of the collected network quality measurement data.

6. The method of claim 1, wherein the normalized quality attributes are normalized into user understandable units such as seconds, kbps, and cost/byte.

7. The method of claim 1, wherein the quality metric is constructed using a linear and functional combination of normalized quality attributes including one or more of the RTT, uplink speed, downlink speed and cost/byte.

8. The method of claim 3, wherein the minimum quality threshold depends on the data activity level of the active network access technology.

9. The method of claim 4, wherein the delta quality threshold is one of current access technology dependent, candidate access dependent and/or data state dependent.

10. The method of claim 4, wherein the delta quality threshold relates to the static or dynamic changes in the time an access technology takes to switch.

11. A method for selecting a network access technology, the method comprising:
calculating based on collected network quality measurement data an access technology quality metric for at least one active network access technology;
calculating based on collected network quality measurement data one or more access technology quality metrics for one or more available network access technologies;
determining an optimum network access technology based on the quality metric of the active network access technology and the quality metrics of the one or more available network access technologies; and
switching from the active network access technology to the optimum network access technology, wherein the optimum network access technology is selected from the one or more available network access technologies.

12. The method of claim 11, wherein determining the optimum network access technology includes:
computing one or more delta quality metrics as a function of the quality metric for the active network access technology and quality metrics for the one or more available network access technologies; and
comparing the one or more delta quality metrics with an access technology delta threshold to determine the optimum network access technology.

13. The method of claim 12, wherein a quality metric is constructed using a linear and functional combination of normalized quality attributes, including one or more of the RTT, uplink speed, downlink speed, and cost/byte.

14. The method of claim 13, wherein the normalized quality attributes are constructed using a linear and functional combination of the collected network quality measurement data.

15. The method of claim 12, wherein the delta quality threshold is one of current access technology dependent, candidate access dependent and/or data state dependent.

16. The method of claim 12, wherein the delta quality threshold relates to the static or dynamic changes in the time an access technology takes to switch.

17. A system for selecting a network access technology, the system comprising:
a two or more network access technologies;
a memory for storing network quality measurement data for the two or more network access technologies; and
a processor configured to
calculate based on the stored network quality measurement data one or more quality metrics for the one or more network access technologies; and
determine an optimum network access technology based on the calculated quality metrics of the one or more available network access technologies.

18. The system of claim 17, wherein the processor is further configured to
compute one or more delta quality metrics as a function of the quality metric for the one or more available network access technologies; and
compare the one or more delta quality metrics with an access technology delta threshold to determine the optimum network access technology.

19. The system of claim 18, wherein a quality metric is constructed using a linear and functional combination of normalized quality attributes, including one or more of the RTT, uplink speed, downlink speed and cost/byte.

20. The system of claim 19, wherein the normalized quality attributes are constructed using a linear and functional combination of the stored network quality measurement data.

21. A method for selecting a network access technology, the method comprising:
collecting network quality measurement data for two or more available network access technologies, including at least one active network access technology;
calculating based on the collected network quality measurement data two or more quality metrics for the available network access technologies;
comparing the quality metric for the active network access technology with a minimum quality threshold to determine whether to switch to another available network access technology;
if the compared quality metric is lower than the minimum quality threshold, calculating two or more delta quality metrics for the available network access technologies as a difference between the quality metric for the active network access technology and the quality metrics for the available network access technologies; and
comparing the delta quality metrics with an access technology delta threshold to determine the optimum network access technology.

22. The method of claim 17, further comprising switching from the active network access technology to the optimum network access technology identified by the delta quality metric that exceeds the access technology delta threshold.
